(19) United States
(12) Patent Application Publication
(10) Pub. No.: US 2020/0121423 A1
(43) Pub. Date: Apr. 23, 2020

(54) SYSTEM FOR MOVING TEETH AND TEETH DECORATION

(71) Applicant: Hui Feng, Shanghai (CN)

(72) Inventor: Hui Feng, Shanghai (CN)

(21) Appl. No.: 16/657,689

(22) Filed: Oct. 18, 2019

Related U.S. Application Data
(60) Provisional application No. 62/747,400, filed on Oct. 18, 2018.

(51) Int. Cl. A61C 7/08

(52) U.S. Cl. CPC A61C 7/08; A61C 2201/002

(57) ABSTRACT

Provided herein is a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement, (b) optionally one or more intermediate appliances having geometries selected to progressively reposition the teeth from the first intermediate arrangement to successive intermediate arrangements including a last intermediate tooth arrangement, and (c) at least one final appliance having a geometry selected to progressively reposition the teeth from the initial tooth arrangement or the last intermediate arrangement to the final tooth arrangement. The system comprises a decorative element on a labial side of the at least one first appliance, the optional one or more intermediate appliances, or the at least one final appliance.

### CROSS-REFERENCE TO RELATED APPLICATIONS

This application claims the benefit of U.S. provisional application Ser. No. 62/747,400, filed Oct. 18, 2018, the teaching of which being incorporated herein by reference in its entirety.

### FIELD OF THE SYSTEM

The present invention relates generally to the field of orthodontics.

### BACKGROUND OF THE SYSTEM

Conventional method of repositioning teeth is to make users wear what are commonly referred to as “braces.” Braces include a variety of appliances such as brackets, archwires, ligatures, and O-rings. The procedures of conventional orthodontics are briefly described here: Before fastening braces to a user's teeth, at least one appointment is typically scheduled with the orthodontist, dentist, and/or X-ray laboratory so that X-rays and photographs of the user's teeth and jaw structure can be taken. Also during this preliminary meeting, or possibly at a later meeting, an alginate mold of the user's teeth is typically made. This mold provides a model of the user's teeth that the orthodontist uses in conjunction with the X-rays and photographs to formulate a treatment strategy. The orthodontist then typically schedules one or more appointments during which braces will be attached to the user's teeth.

At the meeting during which braces are first attached, the teeth surfaces are initially treated with a weak acid the acid optimizes the adhesion properties of the teeth surfaces for brackets and bands that are to be bonded to them. The brackets and bands serve as anchors for other appliances to be added later. After the acid step, the brackets and bands are cemented to the user's teeth using a suitable bonding material. No force-inducing appliances are added until the cement is set. For this reason, it is common for the orthodontist to schedule a later appointment to ensure that the brackets and bands are well bonded to the teeth.

The primary force-inducing appliance in a conventional set of braces is the archwire. The archwire is resilient and is attached to the brackets by way of slots in the brackets. The archwire links the brackets together and exerts forces on them to move the teeth over time. Twisted wires or elastomeric O-rings are commonly used to reinforce attachment of the archwire to the brackets. Attachment of the archwire to the brackets is known in the art of orthodontia as “ligation” and wires used in this procedure are called “ligatures.” The elastomeric O-rings are called “plastics.”

After the archwire is in place, periodic meetings with the orthodontist are required, during which the user's braces will be adjusted by installing a different archwire having different force inducing properties or by replacing or tightening existing ligatures. Typically, these meetings are scheduled every three to six weeks.

Therefore, attaching the appliances to a user's teeth is tedious and time-consuming enterprise and requires many meetings with the treating orthodontist.

Various methods have been proposed to simplify and to reduce the cost of orthodontics with limited success. For example, Kuroda et al. (1996) Am. J. Orthodontics 110:365-369 describes a method for laser scanning a plaster dental cast to produce a digital image of the cast. See also U.S. Pat. Nos. 5,605,459, 5,533,895; 5,474,448; 5,454,717; 5,447,432; 5,431,562, 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. Nos. 5,338,198, 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862, 3,860,803, 3,660,900; 5,645,421; 5,055,039; 4,798,534; 4,856,991; 5,035,613; 5,059,118, 5,186,623; and 4,755,139.

FIG. 1 shows the background technology of the instant application. In FIG. 1, reference labels 1 and 2 show the labial and buccal sides or surfaces of an appliance, and reference labels 3 and 4 show the lingual side or surface of an appliance, each of the appliances comprising cavities that correspond to each tooth of a dental arch. Each of the appliance is digitally made according to a prescription by a treating doctor according to the background technology. In particular, according to the existing background technology, except for the shapes and geometries, each of the appliances is made of the same material having the same chemical, physical, mechanical, and biological parameters that, to each appliance, each wall of each cavity of each appliance is indistinguishably made of the same material and has the same thickness.

U.S. Pat. Nos. 6,398,548 and 6,554,611 describes using a computer program predict the teeth movement from initial tooth positions to the final tooth positions and design and fabricate a series of appliances having different geometries to achieve the repositioning of the teeth from their initial positions to their final positions in one set of appliances in that the user receives a whole set of appliances from the beginning to the finish. The appliances are numbered or marked in the sequence for use. The problem is that if certain tooth movement is behind the expected tooth position, the discrepancy between actual tooth position and expected (predicted) tooth position will most likely increase further and further during the course of repositioning. In addition, teeth with increased discrepancies between actual and expected positions will experience a disproportionate load of force relative to the other teeth and lead to increased patient pain and discomfort.

A large part of the reason underpinning orthodontic treatment is of aesthetic nature, which includes the use of clear aligners. However, the existing technology fails to recognize and address the many un-met needs in this regard, e.g, tooth discoloration and beyond.

The embodiments described below address the above identified needs and issues.

### SUMMARY OF THE SYSTEM

In an aspect of the present invention, it is provided a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including:

(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement, and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise a decorative element on a labial side of the at least one first appliance, the optional one or more intermediate appliances, or the at least one final appliance.

In some embodiments, optionally in combination with one or any embodiment of the invention system, the decorative element comprises a non-transparent surface.

In some embodiments, optionally in combination with one or any embodiment of the invention system, the decorative element comprises a glittering material.

In some embodiments, optionally in combination with one or any embodiment of the invention system, the decorative element comprises a fragrance.

In some embodiments, optionally in combination with one or any embodiment of the invention system, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention system, the microparticles comprise an inorganic oxide, an inorganic salt, or a flavoring agent.

In some embodiments, optionally in combination with one or any embodiment of the invention system, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention system, the glittering material comprises gold crystals, silver crystals, diamond crystals, or polymeric crystals.

In some embodiments, optionally in combination with one or any embodiment of the invention system, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention system, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention system, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention system, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention system, the system comprises at least two cycles of appliances.

In some embodiments, optionally in combination with one or any embodiment of the invention system, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention system, any of the cycles comprises two or more appliances, the subsequent appliance having a thickness that differs from the thickness of the prior appliance in the range from about 0.1 to about 2 mm.

In some embodiments, to increase anchorage of the appliance, a dental implant can be used in association with the cycle of appliances. The implant can be palatally placed or buccally placed or placed on the retromolar area.

In another aspect of the present invention, it is provided a method of forming a system for repositioning teeth of a user in need thereof from an initial tooth arrangement to a final tooth arrangement, the user having a dental arch that comprises malpositioned (“MP”) teeth and normal-positioned (“NP”) teeth, the method comprising forming a decorative element on a surface of the system, the system comprising one or more cycles of successive appliances, each cycle of successive appliances including:

(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise the decorative element on a labial side of the at least one first appliance, the optional one or more intermediate appliances, or the at least one final appliance.

In some embodiments, optionally in combination with one or any embodiment of the invention system, the decorative element is formed using an additive or physical attachment or physical or chemical instrumentation.

In some embodiments, optionally in combination with one or any embodiment of the invention method, the additive comprises a dye, microparticles or a glittering material; wherein the physical instrumentation comprises printing, mechanical carving, heat carving or laser etching; and wherein the chemical instrumentation comprises base or acid etching.

In some embodiments, optionally in combination with one or any embodiment of the invention method, the decorative element comprises a non-transparent surface.

In some embodiments, optionally in combination with one or any embodiment of the invention method, the decorative element comprises a glittering material.

In some embodiments, optionally in combination with one or any embodiment of the invention method, the decorative element comprises a fragrance.

In some embodiments, optionally in combination with one or any embodiment of the invention method, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention method, the microparticles comprise an inorganic oxide, an inorganic salt, or a flavoring agent.

In some embodiments, optionally in combination with one or any embodiment of the invention method, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention method, the glittering material comprises gold crystals, silver crystals, diamond crystals, or polymeric crystals.

In some embodiments, optionally in combination with one or any embodiment of the invention method, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention method, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention method, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention method, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention method, the system comprises at least two cycles of appliances.

In some embodiments, optionally in combination with one or any embodiment of the invention method, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention method, any of the cycles comprises two or more appliances, the subsequent appliance having a thickness that differs from the thickness of the prior appliance in the range from about 0.1 to about 2 mm.

In a further aspect of the present invention, it is provided a method of using a system for repositioning teeth, comprising applying the system to a user to cause the teeth to be repositioned from an initial tooth arrangement to a final tooth arrangement, the system comprising one or more cycles of successive appliances, each cycle of successive appliances including:

(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise the decorative element on a labial side of the at least one first appliance, the optional one or more intermediate appliances, or the at least one final appliance.

In some embodiments, optionally in combination with one or any embodiment of the invention system, the decorative element is formed using an additive or physical attachment or physical or chemical instrumentation.

In some embodiments, optionally in combination with one or any embodiment of the invention method, the additive comprises a dye, microparticles or a glittering material; wherein the physical instrumentation comprises printing, mechanical carving, heat carving or laser etching; and wherein the chemical instrumentation comprises base or acid etching.

In some embodiments, optionally in combination with one or any embodiment of the invention method, the decorative element comprises a non-transparent surface.

In some embodiments, optionally in combination with one or any embodiment of the invention method, the decorative element comprises a glittering material.

In some embodiments, optionally in combination with one or any embodiment of the invention method, the decorative element comprises a fragrance.

In some embodiments, optionally in combination with one or any embodiment of the invention method, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention method, the microparticles comprise an inorganic oxide, an inorganic salt, or a flavoring agent.

In some embodiments, optionally in combination with one or any embodiment of the invention method, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention method, the glittering material comprises gold crystals, silver crystals, diamond crystals, or polymeric crystals.

In some embodiments, optionally in combination with one or any embodiment of the invention method, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention method, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention method, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention method, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention method, the system comprises at least two cycles of appliances.

In some embodiments, optionally in combination with one or any embodiment of the invention method, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention method, any of the cycles comprises two or more appliances, the subsequent appliance having a thickness that differs from the thickness of the prior appliance in the range from about 0.1 to about 2 mm.

### BRIEF DESCRIPTION OF THE DRAWINGS

FIG. 1 shows the prior art orthodontic appliances.

FIGS. 2 and 3 show an embodiment of the invention appliance.

FIG. 4 shows an embodiment of invention method of treatment of malpositioned tooth/teeth of a subject in need thereof.

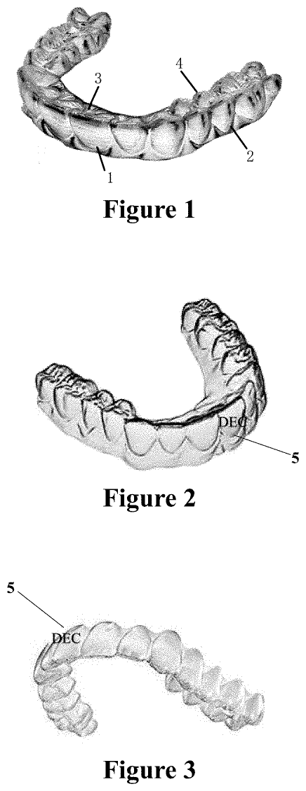

### DESCRIPTION OF DETAILED EMBODIMENTS

### Definitions

As used herein, the term “non-transparent” refers to the attribute of an appliance of invention that renders the original color of tooth/teeth of a user of the appliance invisible or substantially invisible.

As used herein, the term “translucent” refers to light being permitted to pass through but diffusing it so that persons, objects, etc., on the opposite side are not clearly visible.

As used herein, the term “identical appliances” refers to appliances that are identical to each other with respect to geometries, materials forming the appliances, and/or physical dimensions of the appliances. Relatedly, the term “copy” of an appliance (“parent appliance”) refers to a copy appliance of the parent appliance that is identical to the parent appliance with respect to the geometries, materials forming the appliances, and/or physical dimensions of the appliances, and, in this context, the term “duplicate appliances” is used interchangeably with the term “duplicates” or “duplicate appliances” and refers to a copy appliance of the parent appliance that is identical to the parent appliance with respect to each of the geometries, materials forming the appliances, and physical dimensions of the appliances.

### Decorative Element

As used herein, the term “decorative element” refers to an element that is aesthetic appealing or matter of value of subjectivity to a user of the invention system disclosed herein.

A decorative element useful in the present invention can be any aesthetic features that formed of a biocompatible material. For example, a decorative element can comprise a glittering material, a matter of color, such as an organic or inorganic dye or an object of physical or chemical instrumentation, a pattern, or design.

In some embodiments, the decorative element comprises a glittering material. Examples of glittering materials can be or can comprise, for example, organic crystals or inorganic crystals. In some further embodiments, a glittering material can comprise gold crystals, silver crystals, or diamond crystals.

In some embodiments, the decorative element can comprises a figurative element, a numeric element or an alphabetic element. Examples of such figurative element can be a shape of a start, a shape of heart, a human figure, an animal figure, a plant, a flower, a science or technology symbol, formula, or structure, an artistic work, a work of engineering, a natural scene, a pattern, or a design. In some embodiments, such figurative element can be of artistic work, e.g., drawing, painting, or sculpture, architecture, etc. In some further embodiments, such figurative element can be of work of engineering, e.g., a building or bridge. In some further embodiments, such figurative element can be of a natural scene, e.g., ocean, mountain, river, lake, tree, tree, forest, beach, or park.

In some embodiments, the decorative element can comprises a fragrance. Such fragrance can provide physiologically appealing senses, and, the fragrance can be, for example, senses of a scent, a sexual hormone, and/or a mouth-odor masking agent.

FIGS. 2 and 3 each show an embodiment of the invention appliance having a decorative element 5. FIG. 2 shows an appliance for the lower dental arch having a decorative element on the labial side of a tooth, 5, and FIG. 3 shows an appliance for the upper dental arch having a decorative element on the labial side of a tooth, 5.

### Non-Transparent Surface

The non-transparent surface useful in the present invention can be formed of any biocompatible material(s). In some embodiments, the non-transparent surface can comprise microparticles. Such microparticles can comprise an inorganic oxide or an inorganic salt, for example. In some embodiments, the microparticles can comprise a material that is an oxide, a phosphate, a sulfate, a fluoride, chloride, a flavoring agent, a silicate, an aluminate, or a combination thereof.

In some further embodiments, the microparticles can comprise a material such as TiO₂, CaCO₃, Al₂O₃, SiO₂, a silicate, a sulfate, a phosphate, a fluoride, a chloride, a flavoring agent, or a combination thereof.

### Teeth Repositioning System

In an aspect of the present invention, it is provided a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including:

(a) at least one first appliance having a geometry selected to reposition the teeth from the initial tooth arrangement to a first intermediate arrangement or the final tooth arrangement:
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise a decorative element on a labial side of the at least one first appliance, the optional one or more intermediate appliances, or the at least one final appliance.

In some embodiments, optionally in combination with one or any embodiment of the invention system, the decorative element comprises a non-transparent surface.

In some embodiments, optionally in combination with one or any embodiment of the invention system, the decorative element comprises a glittering material.

In some embodiments, optionally in combination with one or any embodiment of the invention system, the decorative element comprises a fragrance.

In some embodiments, optionally in combination with one or any embodiment of the invention system, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention system, the microparticles comprise an inorganic oxide, an inorganic salt, or a flavoring agent.

In some embodiments, optionally in combination with one or any embodiment of the invention system, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention system, the glittering material comprises gold crystals, silver crystals, diamond crystals, or polymeric crystals.

In some embodiments, optionally in combination with one or any embodiment of the invention system, the decorative element comprises a figurative element, a numeric element or an alphabetic element such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention system, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention system, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention system, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention system, the system comprises at least two cycles of appliances.

In some embodiments, optionally in combination with one or any embodiment of the invention system, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention system, any of the cycles comprises two or more appliances, the subsequent appliance having a thickness that differs from the thickness of the prior appliance in the range from about 0.1 to about 2 mm.

In some embodiments, to increase anchorage of the appliance, a dental implant can be used in association with the cycle of appliances. The implant can be palatally placed or buccally placed or placed on the retromolar area.

As used herein, the term “successive appliance” refers to an appliance having a geometry or geometries for repositioning a tooth or teeth from one position, which can be an initial position or an intermediate position, to another position, which can be an intermediate position or a final position. In the successive appliances in the system described herein, each successive appliance includes a geometry or geometries different from the geometry or geometries in another successive appliance.

In some embodiments, the system described herein can have successive appliance(s), each of which includes from 2 to 20, 2 to 15, 2 to 10, 2 to 8, or 2 to 5 identical appliances. For example, 2, 3, 4, 5, 6, 7, 8, 9, or 10 identical appliances.

As described in more detail below in connection with the methods of the present system, the systems is planned and all individual appliances for the first cycle fabricated at the outset of treatment, and the appliances is thus be provided to the orthodontic doctor as a single package or system. The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e.g., near zero), while the last appliance of the first cycle is expected to have a larger discrepancy (e.g., larger than zero). The exact units for the discrepancy is expressed as, but not limited to, a percentage, a metric measurement, or other numerical system (e.g., scale of 0 to 25, with 25 being maximum discrepancy). The calculation of the discrepancy can be based to varying degrees on degree of teeth movement required, the appliance dimensions, the appliance material characteristics, and the use or non-usage of anchoring devices (e.g., dental implants in bone). Upon obtaining the proper sequence of appliance usage, the user can place the appliances over his or her teeth at a frequency prescribed by the orthodontist or other treating professional. Unlike braces, the user need not visit the treating professional every time an adjustment in the treatment is made. While the users will usually want to visit their treating professionals periodically to assure that treatment is going according to the original plan, eliminating the need to visit the treating professional each time an adjustment is to be made allows the treatment to be carried out in many more, but smaller, successive steps while still reducing the time spent by the treating professional with the individual user. Moreover, the ability to use polymeric shell appliances which are more comfortable, less visible, and removable by the user, greatly improves user compliance, comfort, and satisfaction.

The individual appliances will preferably comprise a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the user, certain of the teeth will be misaligned relative to an un-deformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step. However, this accommodation or conforming to the misaligned teeth through successive appliance geometries results in increasing discrepancies between actual teeth positions and expected (predicted) teeth positions.

The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e.g., near zero), while the last appliance of the first cycle is expected to have a larger discrepancy (e.g., larger than zero). The exact units for the discrepancy is expressed as, but not limited to, a percentage, a metric measurement, or other numerical system. The calculation of the discrepancy can be based variably on the degree of teeth movement required, the appliance dimensions, the appliance material characteristics, and the use or non-usage of anchoring devices (e.g., dental implants in bone).

The individual appliances described herein also exert different forces on a tooth arrangement. The different force pertaining to each appliance is achieved by increasing thickness and rigidity while keeping the same elastic modulus or changing the material properties such as elastic modulus and stiffness while not changing the thickness or changing any combination of thickness, rigidity, elastic modulus, and/or material properties. Note, the force exerted on a given tooth or series of teeth is distinct, although somewhat dependent on the material and/or mechanical properties of the appliance. The force pertaining to the appliance is generally related to the thickness, rigidity, elastic modulus, and/or material properties of the appliance. In contract, the force exerted on a given tooth or series of teeth is generally related to the actual teeth positions and desired teeth positions, geometry of the appliance in achieving the desired teeth positions, as well as the material and/or mechanical properties of the appliance and whether any anchoring dental implant devices are employed.

In one embodiment, the system described herein includes one or more than one cycle of appliances with differential de-escalting and/or escalating force system (e.g, from high-to-low, low-to-high, high-to-high, low-to-low, high-to-low-to-high, low-to-high-to-low, etc). The combinations of de-escalting and/or escalating force systems are only limited by appliance number per cycle. For example, the system may include a first appliance with high force having a geometry selected to reposition the teeth from the initial tooth arrangement to a first intermediate arrangement, one or more intermediate appliances having geometries and reducing force system selected to progressively reposition the teeth from the first intermediate arrangement to successive intermediate arrangements, and a final appliance with lowest force system in a cycle having a geometry selected to progressively reposition the teeth from the last intermediate arrangement to an end tooth arrangement. If necessary, a new cycle of force system will start from the end tooth arrangement of the previous cycle until the whole treatment finished.

For each cycle, a description of the force systems will be provided to describe the force of each appliance and to suggest to the treating orthodontic doctor the order of using each individual appliance in predetermined differential force which will progressively move the user's teeth toward the final arrangement, a package, said package containing one cycle of appliances, wherein the appliances are provided in a single package to the user. The treating orthodontics will then provide to the user the proper order of using the appliances on the basis of each user's condition and the doctor's professional judgment and discretion.

In some embodiment, the system described herein comprises one or more than one cycle of appliances. Each cycle contains one or more appliances having a differential de-escalting and/or escalating force system as previously described. In some embodiments, each cycle of the system can be marked for the sequence of the cycles.

The different force pertaining to each appliance is made different by changing the dimension and/or material characteristics of the appliances. For example, the appliances can be made to have different thickness to generate different forces. For example, the appliances can have a thickness ranging from about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm or about 2.0 mm. In some other embodiments, different forces of appliances can be achieved using different material forming the appliances. For example, the material can be blended with reinforcement materials such as fibers, pieces, strips, wires, mesh, lattices, networks, interpenetrating networks, or combinations thereof to cause the appliances to have different forces.

To achieve desired speed of orthodontic treatment, the forces of individual appliances in a cycle can be tailored to meet the needs of treatment. For example, in each cycle, the subsequent appliance can be made to differ from the prior appliance stiffness, in the range from, e.g., about 0.1 to about 8 Gpa. In some embodiments, in each cycle of appliance, the prior appliance can be made to have an elastic modulus that differs from the elastic modulus of the subsequent appliance by about 1% to about 800%. In some other embodiments, in each cycle, the subsequent appliance thickness can be made to differ from the prior appliance thickness, in the range from about 0.1 to about 2 mm.

### Appliance-Forming Materials

The appliances can be formed of an elastic material that may include one or more polymers. The polymer is preferably inert and biocompatible. The polymer is also sufficiently flexible to allow easy removal and application for the user, but also sufficiently rigid to allow controlled teeth movement. Any conventional material normally used in dental treatments for fabricating removable appliances can be used in this system. Specific examples of useful polymers include any elastic polymeric materials, such as those commonly used in the art of dentistry, e.g. olefin polymers or copolymers, such as polyethylene, polybutylene, polyisobutylene, polypropylene, ethylene vinyl acetate, polyvinyl alcohol, polystyrene, copolymers that include two or more of ethylene, propylene, butylene, isobutene, pentene, stryene, vinyl acetate, vinyl alcohol and a combination thereof, or a mixture thereof. The polymeric material may further include a material to modify the biocompatibility. Such biocompatibility modifying materials include, e.g., polyethylene glycol, polypropylene glycol, polyethylene oxide or a natural polymer such as cellulose or alginate, collagen, and the like.

In some embodiment, the polymeric materials may further include a reinforcing material such as fibers, chips, wires, glass fibers, carbon fibers, pieces, strips, mesh, lattices, and networks and interpenetrating networks. Some representative reinforcing materials include, for example, micro or nano aluminum oxide phases, carbon fibers, etc, or mixtures thereof.

### Method of Fabrication

In another aspect of the present invention, it is provided a method of forming a system for repositioning teeth of a user in need thereof from an initial tooth arrangement to a final tooth arrangement, the user having a dental arch that comprises malpositioned (“MP”) teeth and normal-positioned (“NP”) teeth, the method comprising forming a decorative element on a surface of the system, the system comprising one or more cycles of successive appliances, each cycle of successive appliances including:

(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise the decorative element on a labial side of the at least one first appliance, the optional one or more intermediate appliances, or the at least one final appliance.

In some embodiments, optionally in combination with one or any embodiment of the invention system, the decorative element is formed using an additive or physical attachment or physical or chemical instrumentation.

In some embodiments, optionally in combination with one or any embodiment of the invention method, the additive comprises a dye, microparticles or a glittering material; wherein the physical instrumentation comprises printing, mechanical carving, heat carving or laser etching; and wherein the chemical instrumentation comprises base or acid etching.

In some embodiments, optionally in combination with one or any embodiment of the invention method, the decorative element comprises a non-transparent surface.

In some embodiments, optionally in combination with one or any embodiment of the invention method, the decorative element comprises a glittering material.

In some embodiments, optionally in combination with one or any embodiment of the invention method, the decorative element comprises a fragrance.

In some embodiments, optionally in combination with one or any embodiment of the invention method, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention method, the microparticles comprise an inorganic oxide, an inorganic salt, or a flavoring agent.

In some embodiments, optionally in combination with one or any embodiment of the invention method, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention method, the glittering material comprises gold crystals, silver crystals, diamond crystals, or polymeric crystals.

In some embodiments, optionally in combination with one or any embodiment of the invention method, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention method, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention method, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention method, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention method, the system comprises at least two cycles of appliances.

In some embodiments, optionally in combination with one or any embodiment of the invention method, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention method, any of the cycles comprises two or more appliances, the subsequent appliance having a thickness that differs from the thickness of the prior appliance in the range from about 0.1 to about 2 mm.

### Method of Forming Appliances

The appliance can be formed by (a) receiving prescribed orthodontic information for a user in need of orthodontic treatment, (b) forming a cycle of appliances comprising individual appliances, and (c) forming a cycle of appliances.

Generally, the appliances can be formed by (1) generating/obtaining an initial data set such as an initial digital data set (IDDS) representing the initial tooth arrangement, (2) generating a digital data set (DDS) or non-digital data set (NDDS) representing an intermediate tooth arrangement, (3) generating an end or a final data set such as a DDS or NDDS representing an end tooth arrangement or a final tooth arrangement, and (4) optionally producing a plurality of successive digital data sets based on both of the first digital data set and the final digital data set, wherein the plurality of successive data sets represent a series of successive tooth arrangements progressing from the intermediate tooth arrangement last end tooth arrangement to the end tooth arrangement or the final tooth arrangement, and (5) forming an appliance or a plurality of appliances based on the digital data sets. In some embodiments, the digital data sets can be converted into visual images representing a tooth arrangement, and the appliances can be formed based on the visual images. Methods of obtaining the IDDS and DDS, generating a visual image based on DDS and forming an appliance based on the visual image are described in U.S. Pat. Nos. 6,398,548; 6,544,611, 5,895,893; 6,244,861; 6,616,444, 5,645,420; and 5,447,432, the teachings of which are incorporated herein by reference.

The initial digital data set may be provided by any techniques known in the art, including digitizing X-ray images, images produced by computer-aided tomography (CAT scans), images produced by magnetic resonance imaging (MRI), images produced by photo scanning, and the like. The images will be three-dimensional images and digitization may be accomplished using known technology. For example, the initial digital data set is provided by producing a plaster cast of the user's teeth (prior to treatment) by techniques known in the art. The plaster cast so produced may then be scanned using laser or other scanning equipment to produce a high resolution digital representation of the plaster cast of the user's teeth.

In a preferred embodiment, a wax bite is also obtained from the user using standard methods. The wax bite allows plaster casts of a user's upper and lower dentition to be placed relative to one another in the centric occlusal position. The pair of casts then can be scanned to provide information on the relative position of the jaw in this position. This information is then incorporated into the IDDS for both arches.

Once the digital data set is acquired, an image can be presented and manipulated on a suitable computer system equipped with computer-aided design software, as described in greater detail below. The image manipulation will usually comprise defining boundaries about at least some of the individual teeth, and causing the images of the teeth to be moved relative to the jaw and other teeth by manipulation of the image via the computer. Methods are also provided for detecting cusp information for the teeth. The image manipulation can be done entirely subjectively, i.e. the user may simply reposition teeth in an aesthetically and/or therapeutically desired manner based on observation of the image alone. Alternatively, the computer system could be provided with rules and algorithms which assist the user in repositioning the teeth. In some instances, it will be possible to provide rules and algorithms which reposition the teeth in a fully automatic manner, i.e. without user intervention once the individual teeth have been repositioned, a final digital data set representing the desired final tooth arrangement will be generated and stored.

An exemplary method for determining the final tooth arrangement is for the treating professional to define the final tooth positions, e.g. by writing a prescription. The use of prescriptions for defining the desired outcomes of orthodontic procedures is well known in the art. When a prescription or other final designation is provided, the image can then be manipulated to match the prescription. In some cases, it would be possible to provide software which could interpret the prescription in order to generate the final image and thus the digital data set representing the final tooth arrangement.

In yet another aspect, methods described herein are provided for producing a plurality of digital data sets representing a series of discrete tooth arrangements progressing from an initial tooth arrangement to a final tooth arrangement. Such methods comprise providing a digital data set representing an initial tooth arrangement (which may be accomplished according to any of the techniques set forth above). A digital data set representing a final tooth arrangement is also provided. Such final digital data set may be determined by the methods described previously. A plurality of successive digital or non-digital data sets are then produced based on the initial digital data set and the final digital data set. Usually, the successive digital data sets are produced by determining positional differences between selected individual teeth in the initial data set and in the final data set and interpolating said differences. Such interpolation may be performed over as many discrete stages as may be desired, usually at least three, often at least four, more often at least ten, sometimes at least twenty-five, and occasionally forty or more. Many times, the interpolation will be linear interpolation for some or all of the positional differences. Alternatively, the interpolation may be non-linear. In a preferred embodiment, non-linear interpolation is computed automatically by the computer using path scheduling and collision detection techniques to avoid interferences between individual teeth. The positional differences will correspond to tooth movements where the maximum linear movement of any point on a tooth is 2 mm or less, usually being 1 mm or less, and often being 0.5 mm or less.

Often, the user will specify certain target intermediate tooth arrangements, referred to as “key frames.” which are incorporated directly into the intermediate digital data sets. The methods of the present system then determine successive digital data sets between the key frames in the manner described above, e.g. by linear or non-linear interpolation between the key frames. The key frames may be determined by a user, e.g. the individual manipulating a visual image at the computer used for generating the digital data sets, or alternatively may be provided by the treating professional as a prescription in the same manner as the prescription for the final tooth arrangement.

In still another aspect, methods described herein provide for fabricating a plurality of dental incremental position adjustment appliances. Said methods comprise providing an initial digital data set, a final digital or non-digital data set, and producing a plurality of successive digital or non-digital data sets representing the target successive tooth arrangements, generally as just described. The dental appliances are then fabricated based on at least some of the digital data sets representing the successive tooth arrangements. Preferably, the fabricating step comprises controlling a fabrication machine based on the successive digital data sets to produce successive positive models of the desired tooth arrangements. The dental appliances are then produced as negatives of the positive models using conventional positive pressure or vacuum fabrication techniques. The fabrication machine may comprise a stereolithography or other similar machine which relies on selectively hardening a volume of non-hardened polymeric resin by scanning a laser to selectively harden the resin in a shape based on the digital data set. Other fabrication machines which could be utilized in the methods of the present system include tooling machines and wax deposition machines.

In still another aspect, methods of the present system for fabricating a dental appliance comprise providing a digital data set representing a modified tooth arrangement for a user. A fabrication machine is then used to produce a positive model of the modified tooth arrangement based on the digital data set. The dental appliance is then produced as a negative of the positive model. The fabrication machine may be a stereolithography or other machine as described above, and the positive model is produced by conventional pressure or vacuum molding techniques.

In a still further aspect, methods for fabricating a dental appliance described herein comprise providing a first digital data set representing a modified tooth arrangement for a user. A second digital data set is then produced from the first digital data set, where the second data set represents a negative model of the modified tooth arrangement. The fabrication machine is then controlled based on the second digital data set to produce the dental appliance. The fabrication machine will usually rely on selectively hardening a non-hardened resin to produce the appliance. The appliance typically comprises a polymeric shell having a cavity shape to receive and resiliently reposition teeth from an initial tooth arrangement to the modified tooth arrangement.

In some embodiments, the orthodontic doctor can take an imprint or scan a last intermediate tooth arrangement after the user has undergone the treatment of one or more cycles of appliances. A digital data set of the last intermediate tooth arrangement of the previous cycle thus can be obtained based on the imprint or scan. This digital data set of the last intermediate tooth arrangement of the previous cycle is then used as the initial point for generating a new set of digital data and visual images based on the new set of digital data representing one or more new intermediate tooth arrangements and a final tooth arrangement for the fabrication of a new cycle of appliances.

In some embodiments, the final tooth arrangement can be achieved with the application of two or more cycles of appliances, and each cycle of the appliances incrementally move the teeth starting from the tooth arrangement positioned by the last appliance of the previous cycle. Cycles of appliances can therefore be made according to the principles described above.

### Method of Use

In a further aspect of the present invention, it is provided a method of using a system for repositioning teeth, comprising applying the system to a user to cause the teeth to be repositioned from an initial tooth arrangement to a final tooth arrangement, the system comprising one or more cycles of successive appliances, each cycle of successive appliances including:

(a) at least one first appliance having a geometry selected to reposition the teeth from the initial tooth arrangement to a first intermediate arrangement or the final tooth arrangement:
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,

wherein the at least one first appliance, the optional one or more intermediate appliances, or the at least one final appliance comprise the decorative element on a labial side of the at least one first appliance, the optional one or more intermediate appliances, or the at least one final appliance.

In some embodiments, optionally in combination with one or any embodiment of the invention system, the decorative element is formed using an additive or physical attachment or physical or chemical instrumentation.

In some embodiments, optionally in combination with one or any embodiment of the invention method, the additive comprises a dye, microparticles or a glittering material, wherein the physical instrumentation comprises printing, mechanical carving, heat carving or laser etching; and wherein the chemical instrumentation comprises base or acid etching.

In some embodiments, optionally in combination with one or any embodiment of the invention method, the decorative element comprises a non-transparent surface.

In some embodiments, optionally in combination with one or any embodiment of the invention method, the decorative element comprises a glittering material.

In some embodiments, optionally in combination with one or any embodiment of the invention method, the decorative element comprises a fragrance.

In some embodiments, optionally in combination with one or any embodiment of the invention method, the decorative element comprises an organic or inorganic dye.

In some embodiments, optionally in combination with one or any embodiment of the invention system, the non-transparent surface comprises microparticles.

In some embodiments, optionally in combination with one or any embodiment of the invention method, the microparticles comprise an inorganic oxide, an inorganic salt, or a flavoring agent.

In some embodiments, optionally in combination with one or any embodiment of the invention method, the decorative element comprises a glittering material.

In some embodiments, optionally in combination with one or any embodiment of the invention system, the glittering material comprises organic crystals or inorganic crystals.

In some embodiments, optionally in combination with one or any embodiment of the invention method, the glittering material comprises gold crystals, silver crystals, diamond crystals, or polymeric crystals.

In some embodiments, optionally in combination with one or any embodiment of the invention method, the decorative element comprises a figurative element, a numeric element or an alphabetic element. Such figurative element can be, e.g., a shape of a start, a shape of heart, a human figure, an animal figure, a plant, a flower, a science or technology symbol, formula, or structure, an artistic work, a work of engineering, a natural scene, a pattern, or a design. Such alphabetic element can be, e.g., a name, a word, a short phrase, or letters such as name initials.

In some embodiments, optionally in combination with one or any embodiment of the invention method, the decorative element comprises a tooth shape or color that makes up a defect in shape or structure of a tooth or a defect in color of a tooth; and the decorative element comprises a non-transparent or translucent white color to mask the tooth discoloration and/or to mask the defect in shape or structure of the tooth.

In some embodiments, optionally in combination with one or any embodiment of the invention method, the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PPLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments, optionally in combination with one or any embodiment of the invention method, the each of the polymeric shells has a labial/buccal wall of thickness (“LBW thickness”) and a palatal/lingual wall thickness (“PLW thickness), the LBW thickness being different from the PLW thickness, and

wherein the LBW thickness or PPLW thickness of cavities receiving MP teeth has a thickness that is higher than that of the cavities receiving the NP teeth in the first appliance and optional one or more intermediate appliances.

In some embodiments, optionally in combination with one or any embodiment of the invention method, the system comprises at least two cycles of appliances.

In some embodiments, optionally in combination with one or any embodiment of the invention method, the LBW thickness or PPLW thickness of the cavities receiving MP teeth has a thickness that is from about 0.1 mm to about 2 mm higher than that of the cavities receiving the NP teeth.

In some embodiments, optionally in combination with one or any embodiment of the invention method, any of the cycles comprises two or more appliances, the subsequent appliance having a thickness that differs from the thickness of the prior appliance in the range from about 0.1 to about 2 mm.

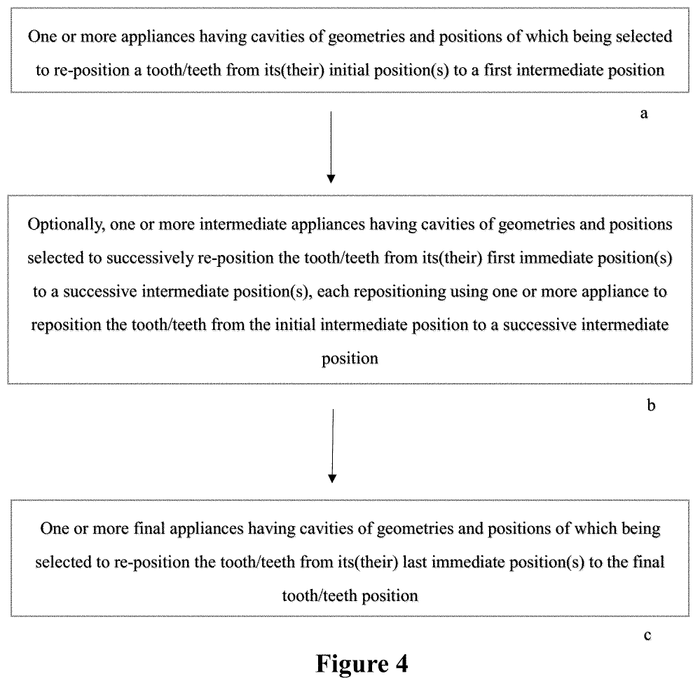

Referring to FIG. 4, in step a, the invention system comprises one or more appliances having cavities and geometries selected to reposition a tooth/teeth from its (their) initial position(s) to a first intermediate position(s) (step a). In step b, optionally, one or more intermediate appliances have cavities of the geometries and positions selected to successively re-position the tooth/teeth from its(their) first immediate position(s) to a successive intermediate position(s), each repositioning using one or more appliance to reposition the tooth/teeth from the initial intermediate position to a successive intermediate position. In step c, one or more final appliances having cavities of geometries and positions of which being selected to re-position the tooth/teeth from its(their) last immediate position(s) to the final tooth/teeth position.

While the above is a complete description of the preferred embodiments of the system, various alternatives, modifications, and equivalents may be used. Therefore, the above description should not be taken as limiting the scope of the system which is defined by the appended claims.

I claim:

1. A system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including:
(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement; and
(c) at least one final appliance having a geometry selected to progressively reposition the teeth from the initial tooth arrangement or the last intermediate arrangement to the final tooth arrangement,
wherein the at least one first appliance, the optional one or more intermediate appliances, or the at least one final appliance comprise a decorative element on a labial side of the at least one first appliance, the optional one or more intermediate appliances, or the at least one final appliance.

2. The system according to claim 1, wherein the decorative element comprises a non-transparent surface, a glittering material, a fragrance, an organic or inorganic dye inorganic dye, a figurative element, a numeric element, and/or an alphabetic element.

3. The system according to claim 2, wherein the non-transparent surface comprises microparticles.

4. The system according to claim 3, wherein the microparticles comprise an inorganic oxide, an inorganic salt, or a flavoring agent.

5. The system according to claim 2, wherein the glittering material comprises organic crystals or inorganic crystals.

6. The system according to claim 2, wherein the glittering material comprises gold crystals, silver crystals, diamond crystals, or polymeric crystals.

7. The system according to claim 2, wherein the figurative element comprises a shape of a start, a shape of heart, a human figure, an animal figure, a plant, a flower, a science or technology symbol, formula, or structure, an artistic work, a work of engineering, a natural scene, a pattern, or a design.

8. The system according to claim 1, wherein the decorative element comprises a tooth shape or color that makes up a defect in shape or structure of a tooth or a defect in color of a tooth, the decorative element comprising a non-transparent or translucent white color to mask the tooth discoloration and/or to mask the defect in shape or structure of the tooth.

9. The system according to claim 8, wherein the defect in color of a tooth is tooth discoloration.

10. The system according to claim 1, wherein the appliances comprise successive locks having different geometries shaped to receive and allow the appliances to reposition teeth from one arrangement to a successive arrangement,
wherein the locks comprise polymeric shells having cavities shaped to receive MP teeth and cavities shaped to receive NP teeth so as to resiliently reposition teeth from one arrangement to a successive arrangement,
wherein each of the polymeric shells has a labile/buccal wall of thickness (“LBW thickness”) and a palatal/lingual wall thickness (“PLW thickness), the LBW thickness being different from the PLW thickness,
wherein the LBW thickness or PPLW thickness of cavities receiving MP teeth has a thickness that is higher than that of the cavities receiving the NP teeth in the first appliance and optional one or more intermediate appliances, and
wherein the system provides specifications of the appliances to allow an orthodontic doctor to prescribe an order for the user to use the appliances based on the specifications.

11. The system according to claim 10, wherein each of the polymeric shells has a labial/buccal wall of thickness (“LBW thickness”) and a palatal/lingual wall thickness (“PLW thickness), the LBW thickness being different from the PLW thickness, and
wherein the LBW thickness or PPLW thickness of cavities receiving MP teeth has a thickness that is higher than that of the cavities receiving the NP teeth in the first appliance and optional one or more intermediate appliances.

12. The system of claim 11, comprising at least two cycles of appliances.

13. The system of claim 12, wherein the LBW thickness or PPLW thickness of the cavities receiving MP teeth has a thickness that is from about 0.1 mm to about 2 mm higher than that of the cavities receiving the NP teeth.

14. The system of claim 12, where any of the cycles comprises two or more appliances, the subsequent appliance having a thickness that differs from the thickness of the prior appliance in the range from about 0.1 to about 2 mm.

15. A method of forming a system for repositioning teeth of a user in need thereof from an initial tooth arrangement to a final tooth arrangement, the user having a dental arch that comprises malpositioned (“MP”) teeth and normal-positioned (“NP”) teeth, the method comprising forming a decorative element on a surface of the system, the system comprising one or more cycles of successive appliances, each cycle of successive appliances including:
(a) at least one first appliance having a geometry selected to reposition the teeth from the initial tooth arrangement to a first intermediate arrangement or the final tooth arrangement;
(b) optionally one or more intermediate appliances having geometries selected to progressively reposition the teeth from the first intermediate arrangement to successive intermediate arrangements including a last intermediate tooth arrangement, and
(c) at least one final appliance having a geometry selected to progressively reposition the teeth from the initial tooth arrangement or the last intermediate arrangement to the final tooth arrangement,
wherein the at least one first appliance, the optional one or more intermediate appliances, or the at least one final appliance comprise the decorative element on a labial side of the at least one first appliance, the optional one or more intermediate appliances, or the at least one final appliance.

16. The method according to claim 15, wherein the decorative element is formed using an additive or physical attachment or physical or chemical instrumentation.

17. The method according to claim 16, wherein the additive comprises a dye, microparticles or a glittering material, wherein the physical instrumentation comprises printing, mechanical carving, heat carving or laser etching; and wherein the chemical instrumentation comprises base or acid etching.

18. The method according to claim 15, wherein the system is according to claim 2.

19. A method of using a system for repositioning teeth from an initial tooth arrangement to a final tooth arrangement, comprising applying the system to a user to cause the teeth to be repositioned from the initial tooth arrangement to the final tooth arrangement, wherein the system is according to claim 2.
